(19) United States
(12) Patent Application Publication
(10) Pub. No.: US 2006/0191132 A1
(43) Pub. Date: Aug. 31, 2006

(54) Coax connector compression tool

(75) Inventor: Noah P. Montena, Syracuse, NY (US)

Correspondence Address: WALL MARJAMA & BILINSKI, 101 SOUTH SALINA STREET, SUITE 400, SYRACUSE, NY, 13202, US

(73) Assignee: John Mezzalingua Associates, Inc., East Syracuse, NY (US)

(21) Appl. No.: 11/068,577

(22) Filed: Feb. 28, 2005

(51) Int. Cl. H01R 43/20

(52) U.S. Cl. 29/747; 29/748; 29/750; 29/755

(57) ABSTRACT

A compression tool having a connector engagement design that improves the quality of the installation of a cable connector onto a cable. The compression tool provides at least one chamfered mating surface that is configured to engage a middle portion of a connector. Engagement of a mating surface with the middle portion of a connector enables each of various embodiments of the tool to interoperate with at least one of a plurality of other types of connectors having differently shaped and sized terminal ends. The chamfered mating Surface provides improved alignment and proper seating of the connector while it is disposed within the compression tool during the period of time before, during and after its compression and installation onto a cable by the compression tool.

### CROSS-REFERENCE TO APPLICATIONS INCLUDING SUBJECT MATTER

The U.S. non-provisional patent application Ser. No. 10/892,645 filed Jul. 16, 2004 (attorney docket 205_{—}181) has common inventorship and includes related subject matter and is hereby incorporated by reference in its entirety.

### FIELD OF THE INVENTION

This invention relates generally to a tool for installing a connector onto a cable, and specifically to a compression tool having a connector engagement design that improves the quality of the installation of a connector onto a cable.

### BACKGROUND OF THE INVENTION

The process of installing a connector onto a coax cable generally involves the skill and effort of a crafts person. Typically, the crafts person uses one or more tools to install a particular type of connector onto a cable. Some tools may be specifically designed for use with a particular type of connector. The installation of some types of connectors are characterized as “craft sensitive”, meaning that the quality of the installation is substantially dependent upon (sensitive to) the amount of care and skill applied by the crafts person to a particular installation of a connector onto a cable.

In some circumstances, a crafts person may not apply sufficient care and/or “rush” the installation of one or more connectors. As a consequence, some or all of these connector installations may be of poor quality. For example, while using a compression tool, a crafts person may force the closure (compression) of a coax connector that is not properly seated and aligned within the compression tool.

This type of installation can result in a compressible portion of the connector, referred to as a compression sleeve, to be forced onto a remaining portion of the connector, referred to as a connector body, in a mis-aligned (cocked) manner. In this state, the improperly compressed and installed connector can lack an effective weather seal and/or lack an effective mechanical attachment to the cable. A defective weather seal can allow moisture to enter and corrode the connector. A defective attachment to the cable can result in the detachment of the connector from the cable or result in a defective (unreliable) electrical connection to the cable.

### SUMMARY OF THE INVENTION

The invention provides a compression tool having a connector engagement design that improves the quality of the installation of a cable connector onto a cable. In some embodiments, the compression tool provides at least one mating surface that is configured to engage a middle portion of a cable connector. Engagement of a mating surface with the middle portion of a connector enables various embodiments of the tool to interoperate with other types of connectors having differently shaped and sized terminal ends.

Preferably, the mating surface that is configured to engage a middle portion of a cable connector is a chamfered mating surface. A chamfered mating surface provides improved alignment and proper seating of the connector while it is disposed within the compression tool during the period of time before, during and after its compression and installation onto a cable by the compression tool.

In some embodiments, the compression tool is configured to install a 50 Ohm coax cable connector onto a coax cable. In other embodiments, the compression tool is configured to install at least one of a plurality of other types of connectors having a variety of shapes and sizes.

### BRIEF DESCRIPTION OF THE DRAWINGS

For a further understanding of these and objects of the invention, reference will be made to the following detailed description of the invention which is to be read in connection with the accompanying drawing, wherein:

FIG. 1 illustrates an embodiment of a compression tool used for installing a cable connector onto a cable.

FIG. 2 illustrates a cable connector that is disposed within the embodiment of the compression tool of FIG. 1.

FIG. 3 illustrates a top view of a cable connector that lacks a chamfered mating surface and that is disposed within an embodiment of a compression tool.

FIG. 4 illustrates a side view of the compression tool shown in FIG. 2.

FIG. 5 illustrates a side cross-sectional view of a cable connector that is disposed within the embodiment of the compression tool of FIG. 2.

FIG. 6 illustrates a side cross-sectional view of the compression tool where the lever is positioned closest to the outer housing and is in a fully compressed position.

FIG. 7 illustrates separated components of the compression tool.

FIG. 8 illustrates a chamfered mating surface disposed within the second opening of the second pusher plate.

FIG. 9 illustrates a top view of the cable connector including the chamfered surface that is disposed within the compression tool.

FIG. 10A illustrates an alternative embodiment of the compression tool that employs a pulling shaft as opposed to a pushing shaft.

FIG. 10B illustrates a cable connector that is disposed within the alternative embodiment of the compression tool of FIG. 10A.

FIG. 10C illustrates a cable connector that is disposed within the alternative embodiment of the compression tool of FIG. 10A that includes an external housing.

FIG. 11 illustrates separated components of the alternative embodiment of the compression tool of FIG. 10A.

FIG. 12 illustrates a top view of the cable connector that is disposed within the alternative embodiment of the compression tool of FIG. 10B.

### DETAILED DESCRIPTION OF THE INVENTION

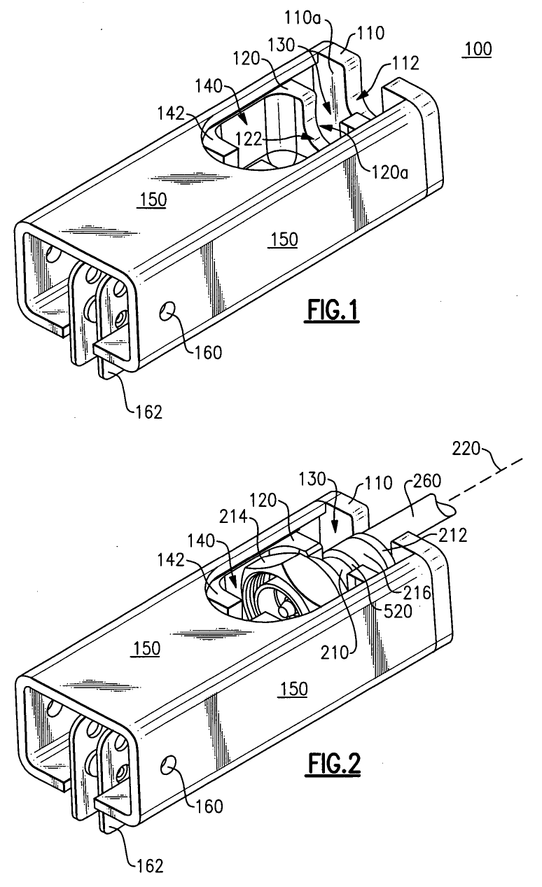

FIG. 1 illustrates an embodiment of a compression tool 100 used for installing a cable connector onto a cable. The compression tool includes a first pusher plate 110 and a second pusher plate 120. The first pusher plate 110 includes a first opening 112 and a first inner surface 110a. The second pusher plate 120 includes a second opening 122 and a second inner surface 120a. The first opening 112 is configured to accommodate the engagement of the first pusher plate 110 with a first mating surface of a cable connector. The second opening 122 is configured to accommodate the engagement of a portion of the second pusher plate 120 with a second mating surface of a cable connector.

The first pusher plate 110 and the second pusher plate 120 bound a distal cavity 130 that is configured to accommodate a compressible portion of the cable connector. The second pusher plate 120 and a perimeter wall 142 bound a second cavity 140. The second cavity 140 is configured to accommodate a remaining portion of the cable connector.

As shown, an outer housing 150 substantially surrounds the compression tool 100 including the distal cavity 130 and the second cavity 140. The outer housing 150 includes an opening 160. A lever 162 is configured to surround and pivot around a pivot shaft (not shown) that is configured to be disposed within the opening 160 within the outer housing 150.

FIG. 2 illustrates a cable connector 210 that is disposed within the embodiment 100 of the compression tool of FIG. 1. As shown, the cable connector is a 50 Ohm cable connector having a longitudinal axis 220 and a distal end portion 212 and a proximal end portion 214. The distal end portion 212 is tapered (narrower) relative to the proximal end portion 214 of the cable connector 210, is disposed within the distal cavity 130 and is physically and electrically connected to a coax cable 260.

The distal end portion 212 of the cable connector 210, included within the compression sleeve 216, is compressible and is configured to be axially compressed between the first pusher plate 110 and the second pusher plate 120. As shown, the longitudinal axis 220 of the connector 210 intersects the coax cable 260 at the distal end 212 of the connector 210. The coax cable 260 is typically spliced (not shown) in preparation for physical connection to the cable connector 210.

The remaining portion of the connector 210 that excludes the compressible portion 216 is referred to as a connector body. As shown, the connector body is partially disposed within the proximal cavity 140 and partially disposed between and outside of the distal cavity 130 and the proximal cavity 140 and includes the proximal end portion 214 of the cable connector 210. The proximal end portion 214 is configured to connect (mate) with another complementary connector interface (not shown).

Other embodiments of the invention are configured to accommodate other types of connectors. For example, as shown in this embodiment, the second pusher plate 120 engages a chamfered mating surface 520 that is disposed onto a shoulder of the compressible portion (compression sleeve) 216 of the cable connector 210. The shoulder is disposed on the proximal edge of the compression sleeve 216. Other embodiments of the compression tool are configured to instead engage a shoulder having a different location and/or different dimensions with respect to another particular connector design and/or engage a flange (protruding rim) or slot disposed onto another particular connector design.

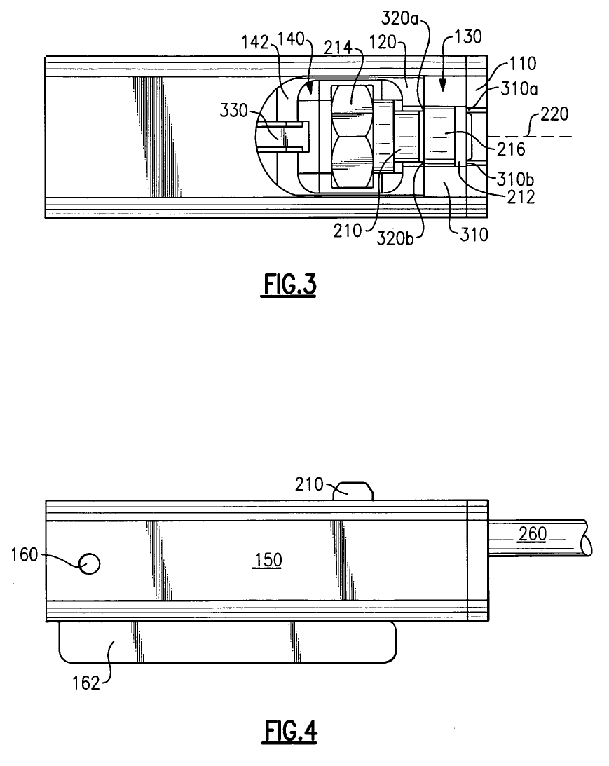

FIG. 3 illustrates a top view of the cable connector 210 and that lacks a chamfered mating surface and that is disposed within an embodiment of a compression tool. Accordingly, the embodiment of the compression tool shown also lacks a chamfered mating surface. As shown, there is engagement between a first pusher plate 110 and a mating surface of the connector 210 at locations 310a and 310b. Likewise, there is engagement between a second pusher plate 120 and a mating surface of the connector 210 at locations 320a and 320b. The mating surfaces 310a, 310b and 320a, 320b are substantially perpendicular to the longitudinal axis of the cable connector 210.

A pushing shaft 330 is attached to a rigid perimeter wall 142 bounding the second cavity 140. The pushing shaft 330 is configured to push the perimeter wall 142 of the cavity 140 and the second pusher plate 120 in a direction towards the first pusher plate 110 in response to movement of the lever 162 in order to compress the compressible portion 216 of the cable connector 210.

FIG. 4 illustrates a side view of the compression tool 100 shown in FIG. 2. As shown, the lever 162 is disposed on the lower side of the compression tool 100. The lever 162 is configured to be hand operated and is positioned closest to the outer housing 150 of the compression tool 100. The lever 162 is configured to pivot around a pivot shaft (not shown) that is disposed within the opening 160 of the outer housing 150. The lever 162 is shown in the closed and fully compressed position.

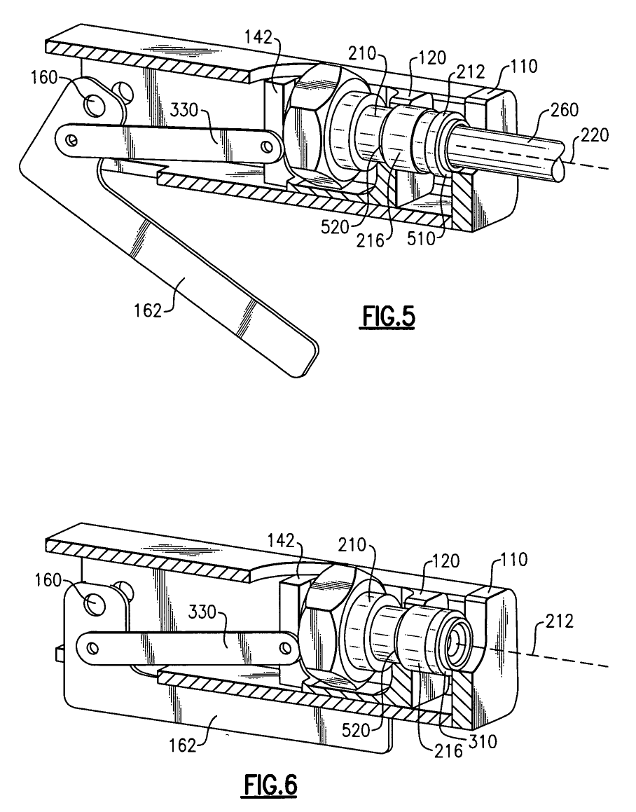

FIG. 5 illustrates a side cross-sectional view of a cable connector 210 that is disposed within the embodiment 100 of the compression tool of FIG. 2. As shown in FIG. 2, the cable connector 210 includes a chamfered mating surface 520. Like the mating surface 310a, 310b shown in FIG. 3, the mating surface 510 that is disposed on the cable connector 210 is angled approximately 90 degrees relative to the longitudinal axis 220 of the cable connector 210. But unlike the mating surface 320a, 320b shown in FIG. 3, the chamfered mating surface 520 that is disposed on the cable connector 210 is angled approximately 45 degrees relative to the longitudinal axis 220 of the cable connector 210. Some of the advantages of incorporating a chamfered mating surface 520 into the compression tool 100 are best described in the discussion of FIG. 8.

Unlike that shown in FIG. 4, the lever 162 is positioned away from a position closest to the outer housing 150 of the compression tool 100. Movement of the lever 162 towards the enclosure 150 of the compression tool causes the pushing shaft 330 to press against the rigid perimeter wall 142 of the second cavity 140 and to move the second pusher plate 120 towards the first pusher plate 110 in order to compress the compressible portion 216 of the cable connector 210. When the lever 162 is disposed closest to the outer housing 150 of the compression tool 100, the compression tool 100 is in a fully compressed position and the cable connector 210 disposed within the compression tool 100 is fully compressed by the compression tool 100.

FIG. 6 illustrates a side cross-sectional view of the compression tool 100 where the lever 162 is positioned closest to the outer housing 150 and is in a fully compressed position. When the lever 162 is disposed closest to the outer housing 150, the components of the compression tool 100 are in their fully compressed positions. As shown, the compressible portion 216 of the cable connector 210 that is disposed within the distal cavity 130 is fully compressed by the compression tool 100.

Movement of the lever 162 to a position closer to the outer housing 150 causes the pushing shaft 330 to apply a force to the perimeter wall 142 in a direction towards the first pusher plate 110. The force applied by the pushing shaft 330 moves the perimeter wall 142 and the second pusher plate 120 towards the first pusher plate 110 in order to further compress the compressible portion 216 of the cable connector 210 disposed within the compression tool 100.

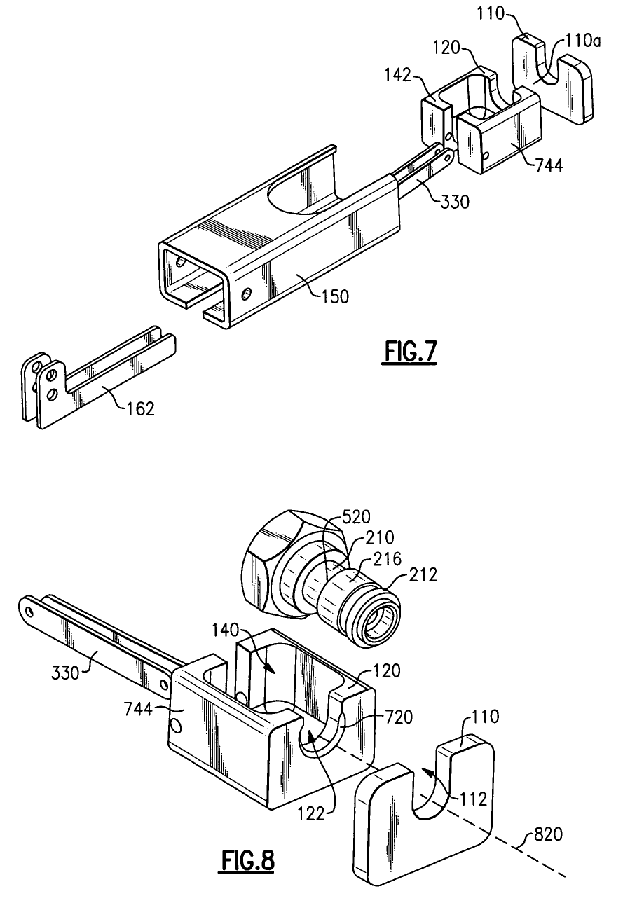

FIG. 7 illustrates separated components of the compression tool 100. As shown, the separated components include the lever 162, the outer housing 150, the pushing shaft 330, the first pusher plate 110 and a rigid enclosure 744 including the second pusher plate 120 and the rigid perimeter wall 142 that bound the proximal cavity 140.

FIG. 8 illustrates a chamfered mating surface 720 disposed within the second opening 122 of the second pusher plate 120. The chamfered mating surface 720 of the compression tool 210 is configured to make flush engagement with the chamfered mating surface 520 of the cable connector 210 (See FIG. 5). Like the chamfered mating surface 520 of the cable connector 210, the chamfered mating surface 720 of the second opening 122 of the second pusher plate 120 is angled approximately 45 degrees relative to the longitudinal axis 220 of the cable connector 210, as it is disposed within the compression tool 210 (See FIG. 5).

An axis of compression 820 of the compression tool 100 is a line disposed through space that indicates an ideal location of the longitudinal axis 220 of a cable connector 210 when it is disposed within the compression tool 100. Accordingly, the chamfered mating surface 720 of the compression tool 100 and the chamfered mating surface 520 of the cable connector 210 are both angled approximately 45 degrees relative to the axis of compression 820 of the compression tool 100.

Engagement of the chamfered mating surface 720 of the compression tool 210 with the chamfered surface 520 of the cable connector 210 centers the longitudinal axis of the cable connector 210 along the axis of compression 820 of the compression tool 210 without using other types of retaining mechanisms which can interfere with the ease of use of a compression tool.

Other types of retaining mechanisms include, for example, spring loaded and/or movable mechanisms built into a compression tool to align (center) a cable connector along an axis of compression within the compression tool and to prevent the cable connector from moving off center and away from the axis of compression. A retention mechanism can obstruct the loading of a connector into a compression tool and cause the compression tool to be more difficult and less efficient to use.

Alignment of a cable connector is important to the correct operation of a compression tool. If the cable connector is not aligned (not properly seated) with respect to the axis of compression while being compressed by the compression tool, an unbalanced (lopsided) compression of the cable connector typically results, constituting an installation of poor quality.

As described within the background section of this document, this type of installation can result in a compressible portion of the connector (compression sleeve) 216 to be forced onto a connector body in a mis-aligned (cocked) manner. In this circumstance, the improperly compressed and installed connector can lack an effective weather seal and/or lack an effective mechanical attachment to the cable. A defective weather seal can allow moisture to enter and corrode the connector. A defective attachment to the cable can result in the detachment of the connector from the cable or result in a defective (unreliable) electrical connection to the cable.

As an alternative to use of other types of retaining mechanisms, the invention employs the chamfered mating surface 720 of the compression tool 100 to engage and align the cable connector 210 via the chamfered mating surface 520 of the compression tool 100.

Furthermore, the chamfered mating surface 720 of the compression tool is configured to mostly surround (by more than 180 degrees) the circumference of the cable connector 210 to prevent the cable connector 210 from sliding upward and/or sliding in any direction along a plane perpendicular to the axis of compression 820 of the compression tool 100. As shown, the chamfered mating surface 720 surrounds the circumference of the cable connector by more than 180 degrees.

The chamfered mating surface 520 of the cable connector 210 is located away from the distal terminal end and proximate to the middle portion of the cable connector 210. Accordingly, the chamfered mating surface 720 of the second pusher plate 120 is located and dimensioned to engage the chamfered mating surface 520 located proximate to the middle portion of the cable connector 210.

By locating the chamfered mating surface 520 of the cable connector 210 proximate to the middle portion of the cable connector 210, the distal terminal end 212 and the proximal end 214 of the cable connector 210 are free to be of a variety of shapes and dimensions necessary to serve the functional requirements of the cable connector 210 without affecting the location, shape and dimension of the chamfered tool engagement surface 520. This aspect of the invention enables the compression tool 100 to accommodate the engagement and compression of multiple types of connectors having a variety of shapes and sizes.

In some embodiments (See FIG. 12), the first inner surface 1910 of said first opening 1112 is also chamfered and configured to engage the first mating surface 1310 of the cable connector 1210 at a location proximate to the distal end 1212 of the compression member. As shown, the first mating surface 1310 of the cable connector 1210 is also chamfered in order to engage the first inner surface 1910 of the first opening 1112 of the first pusher plate 1110. Also, the second mating surface 1520 of the cable connector 1210 is also chamfered in order to engage the second inner surface 1720 of the second opening 1122 of the first pusher plate 1120.

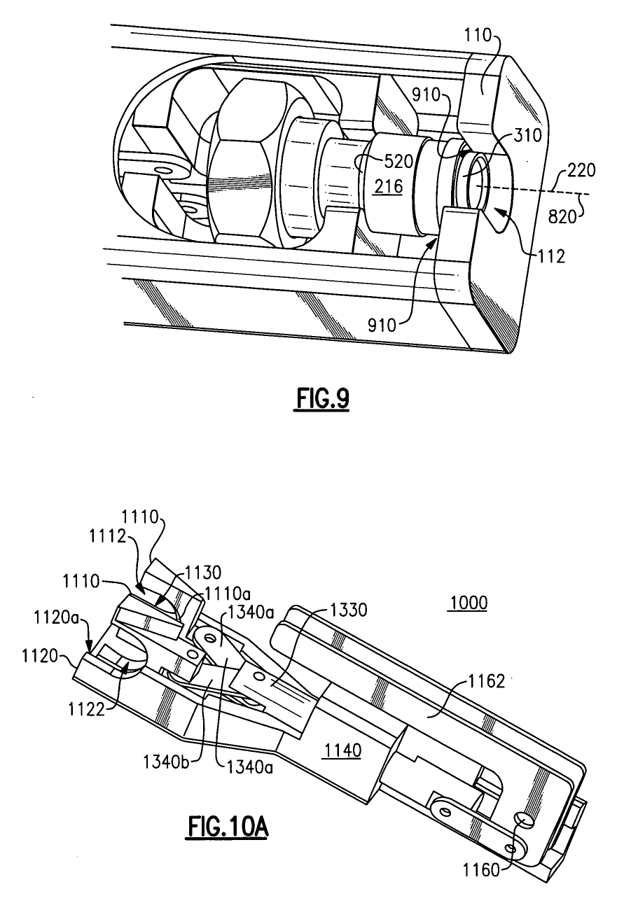

Referring to FIGS. 8 and 9, in some embodiments, the chamfering of both the first and second inner surfaces is also applied to the embodiment 100 of the compression tool shown in FIGS. 1-9. In this type of embodiment, the first inner surface (referenced as 910 of FIG. 9) of said first opening 112 of the compression tool 100 and/or the second inner surface (referenced as 720 of FIG. 8) of the second opening 122 of the compression tool 100 are chamfered in order to engage respective mating surfaces of cable connector.

Note that in some circumstances, disposing a chamfered surface towards the distal end 212 of the cable connector 210 can interfere with other functional requirements of the cable connector 210. Such functional requirements include, for example, the engagement of the connector 210 with a cable (not shown) at the distal end 212, or engagement with another connector (not shown) at the proximal end 214, of the cable connector.

Although the chamfered mating surface 720 is shown to be angled approximately 45 degrees relative to the axis of compression 820, other angles that are not perpendicular to the axis of compression 820 are also effective to align and secure the position of the cable connector 210 before and during compression by the compression tool 100. For example, other angles include, but are not limited to, angles of 30 degrees or 60 degrees.

FIG. 9 illustrates a top view of the cable connector 210 including the chamfered surface 520 that is disposed within the compression tool 100. The mating Surface 310 proximate to the distal terminal end of the cable connector 210 makes flush engagement with a mating surface 910 adjacent to the first opening 112 on the inner side 110a of the first pusher plate 110. As shown, the longitudinal axis 220 of the cable connector 210 and the axis of compression 820 of the compression tool 100 are co-linear. Both mating surfaces 310 and 910 proximate to the first pusher plate 110 are angled approximately 90 degrees relative to the longitudinal axis of the cable connector 210 and the axis of compression of the compression tool 100.

As described with respect to FIGS. 8 and 9, in other embodiments, the mating Surfaces 310 and 910 are chamfered in the same manner as the mating Surfaces 520 and 720. In this type of embodiment, additional centering forces are applied by the engagement of chamfered mating surfaces 310 and 910 to supplement those of the engagement of the chamfered mating surfaces 520 and 720, to better secure the position of the cable connector 210 within the compression tool 100.

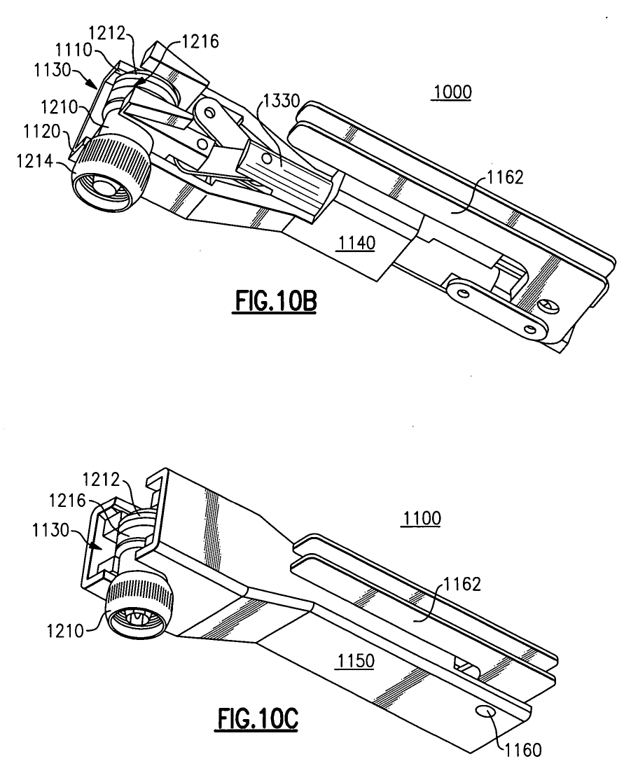

FIG. 10A illustrates an alternative embodiment 1000 of the compression tool that employs a pulling shaft as opposed to a pushing shaft 330. This embodiment is also referred to as a transverse compression tool. Like the embodiment of FIG. 1, the compression tool includes a first pusher plate 1110 and a second pusher plate 1120. The first pusher plate 110 includes a first opening 1112 and a first inner surface 1110a. The second pusher plate 1120 includes a second opening 1122 and a second inner surface 1120a.

This embodiment is configured to compress and install a splice type of cable connector which is physically attached to a separate segment of cable at each of its terminal ends during compression and installation by the compression tool 1100.

A pulling shaft 1330 is pivotably attached two pivoting appendages 1340a, 1340ba. A first pivoting appendage 1340a is attached to a lower portion of a first pusher plate 1110 and a second pivoting appendage 1340a is attached a lower portion of a second pusher plate 1120. The pulling shaft 1330 is configured to pull the pivoting appendages 1340a, 1340ba which are configured to pull the first pusher plate 1110 and the second pusher plate 1120 closer to each other, in response to the lever 1162 being positioned closest to the main body of the compression tool, in order to compress a compressible portion of a cable connector (not shown).

The lever 1162 is configured to be hand operated and is disposed on the right side of the compression tool 1100. The lever 1162 is configured to pivot around a pivot shaft (not shown) that is configured to be disposed within the opening 1160. As shown, the lever 1162 is positioned closest to the main body 1140 of the compression tool 1100. In this position, the compression tool 1100 is in a closed and fully compressed position. If the lever 1162 is positioned away from the main body 1140, the pulling bar 1330 moves towards the first pivoting appendage 1340a and the second pivoting appendage 1340b and causes the first pushing plate 1110 and the second 1120 pushing plate to move farther from each other.

FIG. 10B illustrates a cable connector 1210 that is disposed within the alternative embodiment 1100 of FIG. 10A. The distal end portion 1212 of the cable connector 1210 is compressible and disposed within a distal cavity 1130 bounded by the first pusher plate 1110 and the second pusher plate 1120. A remaining portion 1214 of the cable connector 1210 is disposed outside of the distal cavity 1130.

As shown, the compression tool 1100 in a closed and fully compressed position. Accordingly, the cable connector 1210 that is disposed within the compression tool 1100 is fully compressed. Movement of the lever 1162 away from the main body 1140, moves the first pushing plate 1110 and the second 1120 pushing plate farther from each other and allows easy removal of the cable connector 1210 from the compression tool 1100.

FIG. 10C illustrates a cable connector 1210 that is disposed within the alternative embodiment 1100 of the compression tool of FIG. 10A that includes an external housing 1150. The external housing 1150 surrounds the main body 1140 of he compression tool 1100. The distal end portion 1212 of the cable connector 1210 is compressible and disposed within the distal cavity 1130. The remaining portion of the cable connector 1210 is disposed outside of the distal cavity 1130 and outside of the external housing 1150. As shown, the compression tool 1100 is in a closed and fully compressed position. Accordingly, the cable connector 1210 that is disposed within the compression tool 1100 is fully compressed.

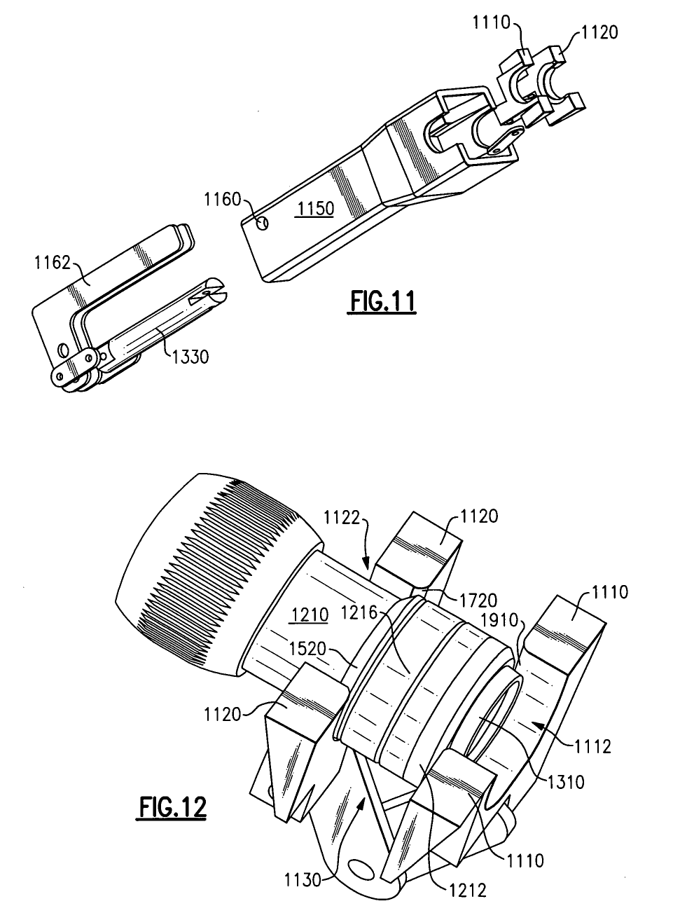

FIG. 11 illustrates separated components of the alternative embodiment 1100 of the compression tool of FIG. 10A. The separated components shown include the lever 1162, the pulling shaft 1330, the external housing 1150 including an opening 1160 configured to accommodate a pivotable shaft (not shown), the first pusher plate 1110 and the second pusher plate 1120 plate.

FIG. 12 illustrates a top view of the cable connector 1210 that is disposed within an embodiment 1100 of the compression tool of FIG. 10B. The first inner surface 1910 that is disposed within the first opening 1112 of the first pusher plate 1110 is configured to engage a first mating surface 1310 of a cable connector 1210. The second inner surface 1720 that is disposed within the second opening 1122 of the second pusher plate 1120 is configured to engage a second mating surface 1520 of the cable connector 1210. As shown, the first inner surface 1910 and the second inner surface 1720 bound a distal cavity 1130 that is configured to accommodate and compress a compressible portion 1216 of the cable connector 1210.

Other variations of the embodiments 100, 1100 of the compression device include other than a hand operated force applying mechanism. For example, in some embodiments, a screw mechanism that applies a compressing force when turned in a clockwise direction and an un-compressing force when turned in a counter clockwise direction. The screw mechanism can be actuated manually via a hand grip or activated automatically using a pneumatic, hydraulic or electrical mechanism.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A compression tool for installing a cable connector onto a cable, the cable connector having a longitudinal axis, a distal end portion, a proximal end portion, a connector body located near the proximal end portion thereof, and a compression member slidingly mounted into operable engagement with the connector body, the compression tool comprising:
a first plate having a first opening, said first opening having a first inner surface that is configured to mate with a first mating surface of the cable connector proximate to a distal end of said compression member;
a second plate having a second opening, said second opening having a second inner surface that is chamfered and configured to engage a second mating surface on said connector body;
a force applying mechanism configured to move said second plate and said first plate toward each other and whereby said compression member and said connector body are compressed along said longitudinal axis into operative engagement.

2. The compression tool of claim 1 where said second mating surface is located on a shoulder or a flange of said connector body.

3. The compression tool of claim 2 where said second mating surface is located on the connector body near a proximal end of said compression member.

4. The compression tool of claim 1 where said second mating surface is disposed within a slot or groove of said connector body.

5. The compression tool of claim 1 where said first inner surface of said first opening is configured to be angled substantially parallel to said second plate and substantially perpendicular to said longitudinal axis.

6. The compression tool of claim 1 where said second inner surface of said second opening is configured to be angled at least partially towards and not parallel to both said first plate and said longitudinal axis.

7. The compression tool of claim 1 where said first opening is a notch within said first plate.

8. The compression tool of claim 1 where said second opening is a notch within said second plate.

9. The compression tool of claim 1 where said first and/or second inner surface is flat.

10. The compression tool of claim 1 where said first and/or second inner surface is curved in a concave fashion.

11. The compression tool of claim 1 where said force applying mechanism is a hand operated mechanism including a handgrip and a pushing shaft that interoperate to apply said force to reduce said distance between said first plate and said second plate when said handgrip is moved towards a remaining portion of said compression tool.

12. The compression tool of claim 11 where said tool is configured to include an opening to enable physical engagement between an end of a cable and one end of the cable connector while said compression member and said connector body of the cable connector are compressed along said longitudinal axis into operative engagement via said force applying mechanism.

13. The compression tool of claim 1 where said force applying mechanism is a hand operated mechanism including a handgrip and a pulling shaft that interoperate to apply said force to reduce said distance between said first plate and said second plate when said handgrip is moved towards a remaining portion of said compression tool.

14. The compression tool of claim 13 where said tool is configured to enable physical engagement between a first end of a cable and a first end of the cable connector and between a second end of a cable and a second end of the cable connector while said compression member and said connector body of the cable connector are compressed along said longitudinal axis into operative engagement via said force applying mechanism.

15. The compression tool of claim 1 where said force applying mechanism is a screw mechanism including at least one handgrip that applies said force when turned to reduce said distance between said first plate and said second plate.

16. The compression tool of claim 1 where said force applying mechanism is a pneumatic, hydraulic or solenoid mechanism that applies said force to reduce said distance between said first plate and said second plate.

17. The compression tool of claim 1 where said cable connector is a 50 Ohm cable connector.

18. The compression tool of claim 1 where said first inner surface is configured to make flush engagement with a cooperatively configured said first mating surface of the cable connector and/or where said second inner surface is configured to make flush engagement with a cooperatively configured said second mating surface of the cable connector.

19. The compression tool of claim 1 where said second mating surface is configured to mostly surround said connector at said second mating surface.

20. The compression tool of claim 1 where said first inner surface of said first opening is chamfered and configured to engage said first mating surface of the cable connector proximate to said distal end of said compression member.

21. The compression tool of claim 1 where said first inner surface of said first opening and/or said second inner surface of said second opening are chamfered.

22. A method for installing a cable connector onto a prepared cable, comprising the steps of:
providing a cable connector having a longitudinal axis, a distal end, a proximal end, a connector body having a shoulder near the proximal end thereof, and a compression member adjacent to the connector body having a tapered distal end, said compression member mounted for sliding engagement with the connector body;
providing a compression tool comprising:
a first plate having a first opening, said opening having a first inner surface that is configured to mate with a first mating surface of the cable connector that is located proximate to the tapered distal end of said compression member;
a second plate having a second opening, said second opening having a second inner surface that is chamfered and configured to engage a second mating surface on said connector body;
a force applying mechanism configured to be activated by a user of said compression tool to reduce a distance between said first plate and said second plate and compress said compression member and said connector body along said longitudinal axis into operative engagement;
disposing the cable connector into said compression tool;
disposing one end of the prepared cable into one end of said compression member; and
activating said force applying mechanism.

23. A compression tool for installing a cable connector onto a cable, the cable connector having a longitudinal axis, a distal end, a proximal end and a compression member having a tapered distal end that is axially slid into operable engagement with a connector body having a shoulder near the proximal end thereof, the compression tool comprising:
a first pusher plate having a first opening, said opening having a first inner surface that is configured to mate with a first mating surface of the cable connector, said first mating surface located proximate to the tapered distal end of the compression member of the cable connector;
a second pusher plate having a second opening, said second opening having a second inner surface that is chamfered and configured to engage a second mating surface of the cable connector that is chamfered and located at a proximal end of said shoulder of the connector body;
a force applying mechanism configured to reduce a distance between said first pusher plate and said second pusher plate and whereby said compression member and said connector body are compressed along said longitudinal axis into operative engagement.
